(19) United States
(12) Patent Application Publication
(10) Pub. No.: US 2002/0121967 A1
(43) Pub. Date: Sep. 5, 2002

(54) Trunk release and warning system

(76) Inventors: Mark A. Bowen, Beverly Hills, CA (US); Jurgen K. Vollrath, San Jose, CA (US)

Correspondence Address: Jurgen K. Vollrath, Fifth Floor, Two Embarcadero Center, San Francisco, CA, 94111, US

(21) Appl. No.: 09/797,763

(22) Filed: Mar. 1, 2001

(51) Int. Cl. B60Q 1/00

(52) U.S. Cl. 340/425.5; 340/438

(57) ABSTRACT

In a trunk release system for a motor vehicle, which allows a user to release the trunk from within the trunk, the system includes a timer to control the release of the trunk or the activation of emergency alarm signals.

The system further includes override switches to override the timing device. The alarm signals may be visual or audible in nature, or may take the form of a radio signal for emitting a distress signal. The system, further, includes the option of including a transmitter/receiver system for establishing two-way communication between a person in a car trunk and emergency services.

### FIELD OF THE INVENTION

This invention relates to a motor vehicle trunk release system, wherein the trunk is releasable from within the trunk, and a system for emitting an alarm or warning signal.

### BACKGROUND OF THE INVENTION

Mechanical trunk release systems have been known for some time. However, they suffer from a variety of problems. For instance, some mechanical devices present children with difficulties since the handle for the release has been shown to be difficult to locate and, even when located, may require a substantial amount of force in order to open the trunk.

Another problem with mechanical releases, is that they are only effective if the occupant is conscious and not in any way incapacitated. For instance, in a situation where a person is abducted and tied up before being placed in the trunk of his car, he may not be able to access the release handle.

U.S. Pat. No. 5,859,479 addressed some of these problems by proposing an electrically activated trunk release making use of an electrical switch. Various applications of this invention have subsequently been proposed and implemented using a variety of activation means for activating the electrical switch. Among the proposals are carbon monoxide level detectors, thermal sensors, and movement detectors, and combinations thereof for triggering the electrical switch.

The problem with some of these systems is that they can cause the trunk to open at inopportune moments. For example, in a situation where a person is forced into the trunk of his car by an assailant, a system that immediately causes the trunk to open when a living being is detected in the trunk, may cause the assailant to kill his victim in order to incapacitate the victim.

The present invention proposes to address these problems.

### SUMMARY OF THE INVENTION

According to the invention there is provided a trunk release system for a vehicle having a trunk with a release mechanism, comprising an electrical switch and a timer connected to the electrical switch, wherein the switch is connected to the trunk release mechanism of the vehicle.

The switch may be activated by any one or more of a number of means, including moving a physical switching element, using carbon monoxide (CO) sensors, using motion monitors, using temperature sensors, etc.

In motor vehicles having an electrical release mechanism, the switch may be connected electrically to the release mechanism. In vehicles having mechanical trunk release mechanisms, the invention includes an electric motor connected to the mechanical release mechanism, and activated by the switch.

The system may include a memory device for storing timing information used by the timer.

The system may include a user interface such as a key pad for entering information. The user interface may be used to enter timing information used by the timer. The system may include a controller for controlling the input of information from the user interface. For instance, a code or password may have to be entered by a user which may be checked against a pre-stored code in a memory of the system. In the absence of a time being entered, the timer may issue a trunk release signal after expiration of a default period of time.

The invention, further, contemplates the use of an alarm or emergency signal that is activated in conjunction with the trunk release system or independent of the timer information. The alarm or emergency signal may include one or more of flashing lights, which may flash in a certain sequence, e.g., in Morse code, an audible alarm or horn, and a radio signal. Where the emergency signal is evident to the casual observer, e.g. flashing lights visible from outside the vehicle, the emergency signal may be coupled to the timer of the trunk release system or to a separate timer. In the case of an emergency signal that takes the form of a radio signal that is emitted, the emission of the signal may be activated independently of the timer since an assailant will remain unaware of the emergency signal and therefore is unlikely to engage in rash behavior. On the other hand, it will be appreciated that a visible or audible alarm may, in fact, serve as a deterrent, and cause an assailant to give up his quest. Thus immediate activation of a visual or audible alarm when the trunk is closed with a living being inside, may be advantageous.

The radio signal may be coupled to a global positioning system to locate the vehicle.

The trunk release system and emergency signal preferably include an override facility for activating the electrical switch even if the timer has not completed its timing sequence. For instance, the electrical switch may be connected to a physically activation element such as a button or toggle lever.

The system may include an engine cut-off switch located in the vehicle that is coupled to the timer or is activated by a physical switch element in the trunk of the car.

The invention may also include a safe installed in the trunk for storing protection devices such as a gun, pepper mace, or knife.

Preferably the invention includes an air supply means. The air supply means may take the form of an air bottle or one or more air holes in air flow communication with the outside of the vehicle. Access to the air supply means my be linked to a timer activated by the closing of the trunk and detection of the presence of a living being in the trunk. Access to the air supply means may also be gained by an override switch mechanism.

### BRIEF DESCRIPTION OF THE DRAWINGS

FIG. 1 is a simplified sectional side view of part of a motor vehicle having a trunk release system and emergency signal system of the invention;

FIG. 2 is a block diagram of one embodiment of a trunk release system of the invention;

FIG. 3 is a simplified schematic diagram of one embodiment of a trunk release system of the invention;

FIG. 4 is one embodiment of a user interface for use in the invention;

FIG. 5 is a flow chart of the logic of one embodiment of the trunk release system of the invention, and

FIG. 6 is a simplified three dimensional view of one embodiment of a trunk arrangement in accordance with the invention.

### DETAILED DESCRIPTION OF THE DRAWINGS

The present invention seeks to place the victim in control of a situation where he or she is placed into the trunk of a vehicle. In particular it allows the victim to control the activation of a trunk release mechanism by placing him or her in control of the timing of the release.

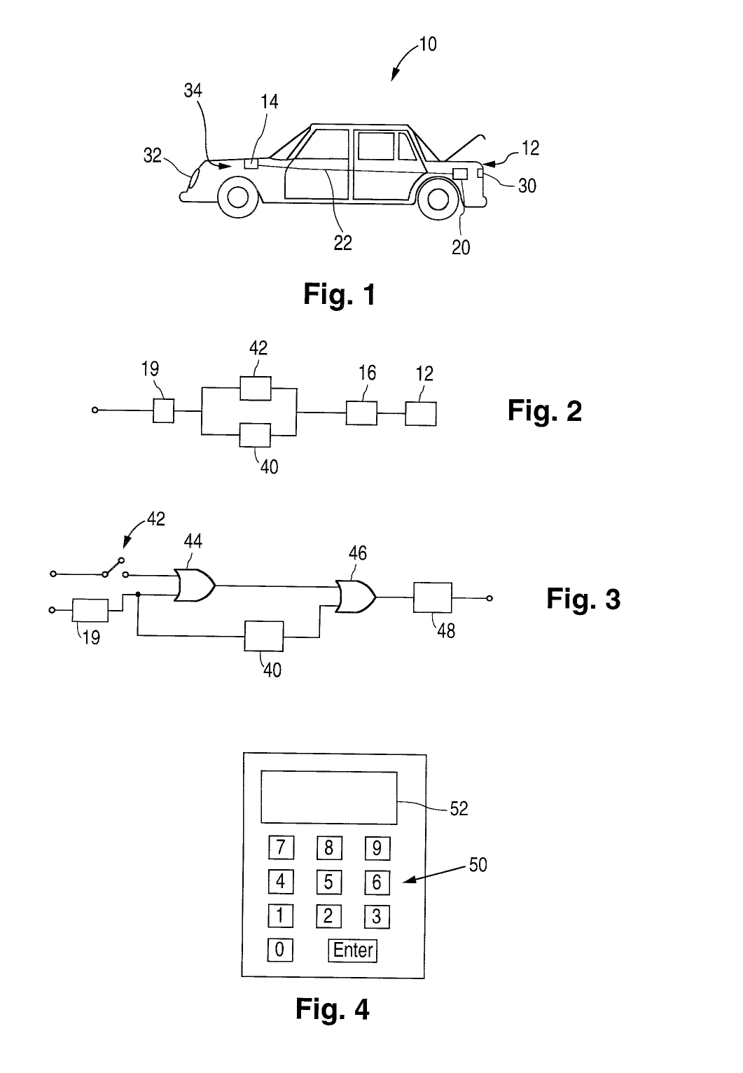

FIG. 1 shows a typical motor vehicle 10 in schematic form, showing an electrically activated trunk release mechanism 12 that receives power from the vehicle's battery 14. The present invention includes an electrical switch 16, shown in FIG. 2, that is located between the power source (not shown) and the release mechanism 12. In one embodiment, the switch 16 is activated by any one of a number of triggering means 19 including motion sensor signals, CO level detector signals, temperature sensor signals, voice activation means, or mechanical switching elements such as a push button, or any combination thereof. In the case of a mechanical switching element, a preferred embodiment includes a light for lighting up the switching element or at least the portion of the trunk where the element is located. It will be appreciated that the voice activation means is especially useful where the person in the trunk has been tied up.

The power source may comprise the car battery 14. In a preferred embodiment, as shown in FIG. 1, the power source 18 includes a separate back-up battery 20 in case the electrical connection 22 between the car battery 14 and the trunk release mechanism 12 is interrupted.

In vehicles that have no electrical trunk release mechanism, the present invention contemplates the inclusion of a separate electric motor connected to the trunk release mechanism of the vehicle, and activated by the switch 16.

In addition to providing a system for releasing the trunk of a vehicle 10, the present invention includes an alarm or warning system that emits a visual warning such as flashing of the rear lights 30 and front lights 32, or emits an audible alarm such as from the car horn 34 or a separate siren mounted on the vehicle, or emits a radio signal from a radio transmitter. In the latter case, the radio signal may be transmitted on an emergency signal wavelength that is monitored by police or private security services. In a preferred embodiment, the system includes not only a transmitter for sending a signal, but includes a transmitter/receiver system that allows two way communication to be established with someone in the trunk of the vehicle 10.

Referring again to FIG. 2, the system of the present invention further includes a timer 40 which delays the activation of the switch 16. In a preferred embodiment, an s override switch 42 is included that can override the timer 40 and release the trunk. This is particularly important in a scenario where the victim is forced into a vehicle that is not his or her own, for example, the assailant's vehicle.

One embodiment of a release mechanism is shown in FIG. 3 in which signals from the activation means 19 and the override switch 42 are fed into an OR gate 44. The output of the OR gate 44 and a signal from the timer 40 are fed into an OR gate 46. The output from the OR gate 46 is connected to an electric motor 48 of the trunk release mechanism. Thus the two gates 44, 46 in this embodiment constitute a switch for releasing the trunk of the vehicle. The motor 48 may be an existing electric motor that forms part of an electrical trunk release mechanism of the vehicle, or, as mentioned above, may be a separate electric motor. It will be appreciated that the system of the invention must still allow a person to release the trunk from outside the trunk for regular day to day operation, therefore, in a preferred embodiment, the system of the invention does not interfere with the regular trunk release mechanism of the vehicle.

It will also be appreciated that, insofar as the system does not include a sensing element but merely includes a mechanical switching element to activate the electronic switching mechanism, a physical action by the victim is required to release the trunk. Such a physical action may be coupled directly to the switch 16 to release the trunk, or via the timer 40. In such an embodiment the circuit can be simplified by eliminating the need for a separate override switch 42 and the gate 44. Instead, the signal from the switching element is fed directly to the switch 16 or via the timer 40 to the switch 16, which in such an embodiment comprises the gate 46. It will be appreciated that the circuit shown in FIG. 3 is by way of example only, in order to show the logic involved in one embodiment. Appropriate driver circuits and other detailed electronic elements are not shown but would be obvious to one skilled in the art.

The timer may be provided with a pre-defined time. For instance, one embodiment of the system of the invention includes a memory device for storing timing information. Instead, a person may enter the release time prior to entering the trunk. Preferably the time can only be entered with the help of a code or other confirmation means such as voice recognition or finger print recognition. One embodiment of the invention contemplates entering timing information using voice recognition means. A preferred embodiment of the invention contemplates a controller for receiving code information and controlling the entry of data for use by the timer. In a typical scenario, a victim about to be forced into his or her trunk may advise the assailant that the trunk will not lock without entering a code. By entering the code, the timer is activated and is subjected to a preset time. Alternatively, the user may include timing information when entering the code information. In a preferred embodiment the user has the flexibility of entering a time when the incident occurs, but has the benefit of a backup default time in the case that he or she is not given the opportunity of entering a time. In one embodiment, the trunk will not close if a code is not entered, thereby forcing an assailant to allow the victim to enter the code or at least advise him of the code. It will be appreciated that in such an embodiment, the system is flexible enough to allow the person entering the code to enter information that will not release the trunk after a certain time, thus avoiding the trunk opening at inopportune times during ordinary day to day operation. However such overriding of the timer clearly must not, in any way, interfere with the override switch 42 or the ability to reenter different timing information.

In another embodiment the system circuit may be such so as to allow the trunk to close without entering a code, but automatically starting the timer for a default countdown period when a sensor detects a living being in the trunk.

In an embodiment in which the victim enters a code and possibly also timing information, a user interface is included in the system of the invention. This may take the form of a key pad 50 as shown in FIG. 4. Preferably the user interface includes a display 52, such as an LCD display or monitor to provide visual feedback to the user. It will be appreciated that the keypad may be mounted in the trunk or be provided on a handheld unit 53 such as a key chain transmitter for remotely entering information. In the case of a handheld transmitter unit, a radio, or infra-red, or other receiver is mounted on the vehicle. It will be appreciated that in such an embodiment, the timer may be mounted in the handheld unit or connected to the receiver in the vehicle. Ideally both a handheld unit and a trunk mounted information entry device is provided.

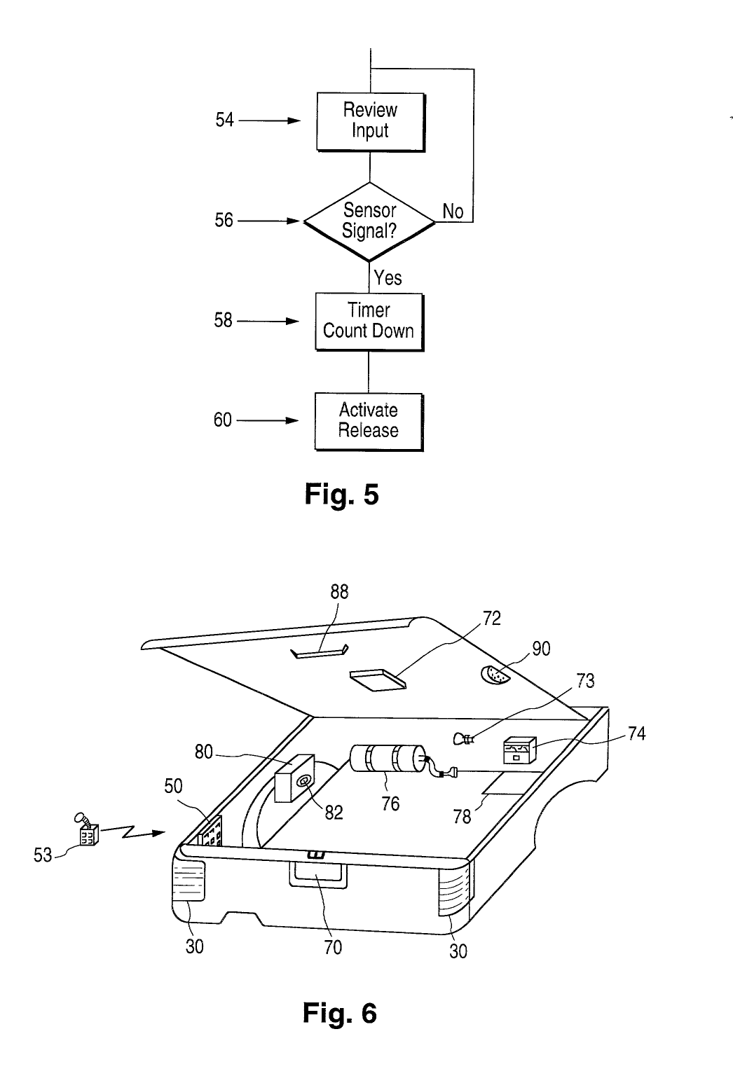

FIG. 5 shows a flow diagram of the logic involved in one embodiment of the system of the invention. In block 54, the inputs from one or more activation devices 19 are monitored. If a signal is detected (block 56) the timer count down is started (block 58). If no input signal from a device 19 is detected, the monitoring of the inputs continues. Once the timer has counted down to the time pre-specified in memory, or specified by the user at the time of the incident, the switch 16 is triggered to activate the trunk release.

Another embodiment of the invention avoids the use of a sensor triggering means and simply provides for the release of the trunk after a specified period of time.

It will be appreciated that in such an embodiment of the invention, the timing information cannot be pre-specified but is entered by the victim at the time the incident occurs. Again, an internal override switch may be included to allow early release of the trunk prior to the countdown of the timer. Alternatively, the victim in the trunk can simply reenter the timing information once inside the trunk. To avoid children inadvertently locking themselves in the trunk, the preferred embodiment prevents the trunk from locking without first entering a code.

As mentioned above, the present invention also contemplates the inclusion of an alarm signal. Such an alarm signal may be connected to the timing circuit to trigger the alarm in conjunction with the release of the trunk. Alternatively, the alarm signal may be separately triggered, immediately when a signal from one of the activation means 19 is detected, thus avoiding a timer altogether for the alarm system. In another embodiment the alarm signal is provided with its own timer.

It will be appreciated that more than one type of alarm signal can be emitted. In the case where the alarm signal includes a radio signal that can be picked up by an emergency service, the timing to start emitting the signal may be different from the timing for other emergency or alarm signals. For example, in one embodiment, the radio signal may be emitted as soon as the trunk is closed and a living being is detected in the trunk, whereas the head lights 32 and rear lights 30 only start flashing once the vehicle is started. Thus the invention is broad enough to cover a system that includes more than one timer. It will also be appreciated that the invention is broad enough to include a mechanical trunk release system coupled to a mechanical timing mechanism such as the mechanical timers that are commonly used in kitchens for timing cooking.

As discussed above, one embodiment of the invention includes a transmitter/receiver system for establishing two-way communication between a person in the trunk and predefined entities such as police or private emergency services. The two-way communication link may be established in response to a signal from an activation means 19, either with or without being subjected to a time delay produced by a timer. The communication link may take the form of radio communication or cellular phone communication. As yet a further feature, one embodiment includes a car phone jack in the trunk of the vehicle. Another embodiment includes a cell phone mounted in the trunk or a key pad, display and speaker/microphone arrangement for dialing out to any desired telephone numbers. In a preferred embodiment the vehicle is fitted with a global positioning system and positional information is relayed to emergency services or law enforcement agencies by means of a radio transmitter. A preferred embodiment also includes means for third parties to interact with the car by locking the passenger compartment or disabling the vehicle. It will be appreciated that this is easily implemented using cellular phone technology as used by On Star to send a signal to a receiver which, in turn activates a servo motor or other means for translating the received signal into a mechanical action.

FIG. 6 shows the trunk section of a car featuring one embodiment of the invention. The rear lights 30 and a separate strobe light 70 emit a visual emergency signal by flashing in a random or predetermined fashion. For example they could flash to spell out S-O-S in Morse code. An internal light 72 is included to illuminate the interior of the trunk when a living being is detected in the trunk. In a preferred embodiment, a flashlight 73 is housed in the trunk, for example, in a housing or on a mounting bracket. The transmitter/receiver system having a user interface in the form of a microphone/speaker 74, is included. It has been known that people trapped in trunks of vehicles have suffocated from lack of oxygen. The present invention contemplates the inclusion of an oxygen canister 76. Furthermore, a releasable panel 78 is included in the trunk, that may be removed or lifted by an occupant to provide access to air outside the vehicle. The key pad 50 is shown secured to a side panel of the interior of the trunk. Furthermore, the present embodiment includes a safe 80 for housing a weapon such as a gun, pepper spray, or knife or any combination thereof, as well as protective gear such as a bullet proof vest or bullet proof blanket. As shown, the safe includes a combination lock 82.

Since the system of the invention includes a timer for releasing the trunk, it will be appreciated that the trunk may be released at a time when the victim is not ready to get out of the trunk, for example, during a high speed chase. A preferred embodiment therefore includes a handle 88 inside the trunk for holding down the trunk lid and to provide a handhold for the victim to stabilize him or herself.

Since the victim may be tied up, a preferred embodiment may include a blade or other cutting means in the trunk. In the embodiment of FIG. 6, a blade (not shown) is mounted in the trunk behind a protective cover 90 which pops open in response to the timer or in response to an occupant pressing against the cover 90.

It will be appreciated that the invention is not limited to any one embodiment discussed and is broad enough to cover other systems that provide a victim or user with the option of becoming involved in the timing feature of the trunk release or alarm signal activation, and provide the victim with survival tools.

What is claimed is:

1. A motor vehicle trunk protection system comprising
an electric switch connected to an electric trunk release motor,
triggering means for triggering the switch, and
a timer for delaying the triggering of the switch for a specified period of time from receiving a signal from the triggering mechanism.

2. A system of claim 1, wherein the triggering means is located in the trunk.

3. A system of claim 2, wherein the triggering means includes a carbon dioxide level detector.

4. A system of claim 2, wherein the triggering means includes a temperature sensor.

5. A system of claim 2, wherein the triggering means includes a motion sensor.

6. A system of claim 1, wherein timing information for the timer is preset.

7. A system of claim 1, wherein timing information for the timer is entered by means of a user interface.

8. A system of claim 7, wherein the user interface includes a key pad.

9. A system of claim 7, wherein the entry of the timing information requires the entry of a code.

10. A system of claim 1, further comprising an override switch within the trunk for overriding the timer to release the trunk.

11. A system of claim 1, further comprising alarm means for notifying people outside the vehicle of the presence of a living being in the trunk.

12. A system of claim 11, wherein the alarm means includes a visual alarm.

13. A system of claim 11, wherein the alarm means includes at least one flashing light.

14. A system of claim 13, wherein the at least one flashing light includes one or more of, one of the front lights, one of the rear lights, or a specially mounted light on the vehicle.

15. A system of claim 11, wherein the alarm means includes an audible alarm.

16. A system of claim 15, wherein the audible alarm includes the horn of the vehicle or a siren mounted on the vehicle.

17. A system of claim 11, wherein the alarm means includes a transmitter for transmitting a radio signal.

18. A system of claim 1, further comprising a two way communication system with a transmitter and a receiver located in the trunk.

19. A system of claim 17, further comprising a global positioning system for providing positioning information about the vehicle.

20. A system of claim 19, wherein the positioning information is transmitted by the transmitter.

21. A system of claim 1, further comprising a light in the trunk which switches on when a living being is detected in the trunk.

22. A system of claim 1, further comprising air supply means.

23. A system of claim 22, wherein the air supply means includes an oxygen bottle.

24. A system of claim 22, wherein the air supply means includes at least one air opening in flow communication with the outside of the vehicle.

25. A system of claim 1, further comprising a safe for housing protection means.

26. A system of claim 25, wherein the protection means includes at least one of, a gun, a knife, and pepper spray.

27. A system for assisting a person locked in a trunk of a motor vehicle, comprising
an electrically activated switch for releasing the trunk,
a triggering mechanism for triggering the switch, and
a timer for timing the release of the trunk.

28. A system of claim 27, wherein the triggering mechanism is triggered by excessive carbon dioxide concentration or a combination of excessive carbon dioxide concentration, motion detected in the trunk, and a timer signal from the timer.

29. A system of claim 27, wherein the timer has default timing information.

30. A system of claim 29, wherein the timer includes time entry means for entering timing information.

31. A system of claim 30, wherein the time entry means includes means for verifying that the person entering the time is authorized to enter the timing information.

32. A system of claim 27, further comprising at least one of, means for emitting an alarm signal to people outside the vehicle, means for two way radio communication for communicating with a person in the trunk, and means for defending oneself.

33. A system of claim 32, wherein the alarm signal is at least one of, a radio signal, audible signal, and visual signal.

34. A system of claim 27, further comprising at least one of means for interacting with a global positioning system to identify the location of the vehicle, and means for locking the passenger compartment doors and windows or disabling the vehicle.

35. A system of claim 27, farther comprising oxygen supply means for a person locked in the trunk.

36. A method of providing a greater choice of options to a person locked in the trunk of a vehicle, comprising
providing the vehicle with means for releasing the trunk, wherein the means for releasing is coupled to a timer for timing the release of the trunk.

37. A method of claim 36, wherein the timer has preset timing information.

38. A method of claim 36, wherein timing information is entered into the timer using a data entry device.

39. A method of claim 36, further comprising providing means for overriding the timer.

40. A method of claim 36, further comprising providing at least one of alarm means, global positioning means for allowing people outside the vehicle to track the location of the vehicle, providing two way communication means inside the trunk, providing defensive and offensive gear inside the trunk, providing a blade for releasing a tied up person, and providing means for third parties outside the vehicle to interact with the vehicle locking mechanism or the vehicle engine.

41. A motor vehicle trunk protection system comprising
an electric switch connected to an electric trunk release motor,
a timer for triggering the switch after a specified period of time, and
means for specifying a timing information to the timer.

42. A system of claim 39, wherein timing information for the timer is entered by means of a user interface.

43. A system of claim 40, wherein the user interface includes a key pad.

44. A system of claim 40, wherein the entry of the timing information requires the entry of a code.

45. A system of claim 42, further comprising an override switch within the trunk for overriding the timer to release the trunk.

46. A system of claim 1, further comprising alarm means for notifying people outside the vehicle whenever timing information has been entered.

47. A system of claim 44, wherein the alarm means is activated after a specified period of time.

48. A system of claim 45, wherein the specified period of time for the alarm means is prespecified or specified when the timing information for the timer is specified.

49. A system of claim 45, wherein the alarm means includes a visual alarm.

50. A system of claim 45, wherein the alarm means includes at least one flashing light.

51. A system of claim 48, wherein the at least one flashing light includes one or more of, one of the front lights, one of the rear lights, or a specially mounted light on the vehicle.

52. A system of claim 45, wherein the alarm means includes an audible alarm.

53. A system of claim 50, wherein the audible alarm includes the horn of the vehicle or a siren mounted on the vehicle.

54. A system of claim 45, wherein the alarm means includes a transmitter for transmitting a radio signal.

55. A system of claim 39, further comprising a two way communication system with a transmitter and a receiver located in the trunk.

56. A system of claim 52, further comprising a global positioning system for providing positioning information about the vehicle.

57. A system of claim 54, wherein the positioning information is transmitted by the transmitter.

58. A system of claim 39, further comprising a light in the trunk which switches on whenever timing information is specified for the timer.

59. A system of claim 39, further comprising air supply means.

60. A system of claim 57, wherein the air supply means includes an oxygen bottle.

61. A system of claim 57, wherein the air supply means includes at least one air opening in flow communication with the outside of the vehicle.

62. A system of claim 39, further comprising a safe for housing protection means.

63. A system of claim 60, wherein the protection means includes at least one of, a gun, a knife, and pepper spray.

64. A method of providing a greater choice of options to a person locked into the trunk of his or her vehicle, comprising
providing the vehicle with means for releasing the trunk in response to timing information entered into a timer.

65. A method of claim 62, wherein timing information is entered into the timer using a data entry device.

66. A method of claim 62, further comprising providing means for overriding the timer.

67. A method of claim 62, further comprising providing at least one of alarm means, global positioning means for allowing people outside the vehicle to track the location of the vehicle, providing two way communication means inside the trunk, providing defensive and offensive gear inside the trunk, providing a blade for releasing a tied up person, and providing means for third parties outside the vehicle to interact with the vehicle locking mechanism or the vehicle engine.
